(19) United States
(12) Patent Application Publication
(10) Pub. No.: US 2022/0242708 A1
(43) Pub. Date: Aug. 4, 2022

(54) CARRYING SYSTEM, CONTROL METHOD, AND PROGRAM

(71) Applicant: TOYOTA JIDOSHA KABUSHIKI KAISHA, Toyota-shi (JP)

(72) Inventors: Yuta ITOZAWA, Nagoya-shi (JP); Kunihiro IWAMOTO, Nagakute-shi (JP); Hirotaka KOMURA, Tokyo (JP); Yutaro TAKAGI, Tokyo (JP)

(73) Assignee: TOYOTA JIDOSHA KABUSHIKI KAISHA, Toyota-shi (JP)

(21) Appl. No.: 17/548,700

(22) Filed: Dec. 13, 2021

(30) Foreign Application Priority Data
Feb. 3, 2021 (JP) 2021-015807

(51) Int. Cl. B66F 9/06; B66F 9/075

(52) U.S. Cl. CPC B66F 9/063; B66F 9/07559

(57) ABSTRACT

This carrying system is a carrying system in which a load is carried by an autonomous mobile robot. The autonomous mobile robot has: a platform on which the load is placed; a control unit that controls the level of the platform; and an engaging part that engages with a predetermined object in a surrounding environment when the platform is raised.

### CROSS-REFERENCE TO RELAIED APPLICATION

This application claims priority to Japanese Patent Application No. 2021-015807 filed on Feb. 3, 2021, incorporated herein by reference in its entirety.

### BACKGROUND

### 1. Technical Field

This disclosure relates to a carrying system, a control method, and a program.

### 2. Description of Related Art

Recently, technologies for carrying things by autonomous mobile robots in factories, warehouses, etc. have been developed. For example, Japanese Unexamined Patent Application Publication No. 2020-007158 (JP 2020-007158 A) discloses a robot that retrieves an item placed on a shelf in a warehouse and carries the item. This robot includes a base, a lift that can be extended upward from the base, and a retrieving unit provided on an upper side of the lift. This robot retrieves an item placed at a high place by raising the retrieving unit.

### SUMMARY

In the system described in JP 2020-007158 A, when the retrieving unit is raised, the robot may fall over due to the raised position of the center of gravity of the robot or other reasons. Thus, what is needed is provision of a technology for improving the stability of a robot when raising a component of the robot that can be raised and lowered.

This disclosure has been made in view of the above circumstances, and an object thereof is to provide a carrying system, a control method, and a program that can prevent an autonomous mobile robot from falling over when raising a platform of the autonomous mobile robot.

One aspect of this disclosure to achieve the above object is a carrying system in which a load is carried by an autonomous mobile robot. The autonomous mobile robot has: a platform on which the load is placed; a control unit that controls the level of the platform; and an engaging part that engages with a predetermined object in a surrounding environment when the platform is raised. In this carrying system, the autonomous mobile robot has the engaging part that engages with the predetermined object, and the autonomous mobile robot can be thereby coupled to the predetermined object. Thus, the autonomous mobile robot can be prevented from falling over.

In the one aspect, the control unit may raise the platform only when engagement of the engaging part is detected. This can prevent the platform from being raised without the engaging part being engaged. Thus, the autonomous mobile robot can be more reliably prevented from falling over.

In the one aspect, the engaging part may be a recessed part that fits on a protruding part of the object. This configuration allows the autonomous mobile robot to be coupled to the predetermined object and can thereby prevent the autonomous mobile robot from falling over.

In the one aspect, the engaging part may be a protruding part that fits into a recessed part of the object. This configuration allows the autonomous mobile robot to be coupled to the predetermined object and can thereby prevent the autonomous mobile robot from falling over.

In the one aspect, the engaging part may be a pin that is moved out from a casing of the autonomous mobile robot toward the object. This configuration allows the autonomous mobile robot to be coupled to the predetermined object and can thereby prevent the autonomous mobile robot from falling over.

In the one aspect, the platform may be provided above a casing of the autonomous mobile robot through a pillar that supports the platform on the upper side of the casing. The engaging part may be an upper surface of the casing. The level of the upper surface may be a level corresponding to the level of a lower surface of an overhang that is provided on the object so as to protrude in a horizontal direction. This configuration allows the autonomous mobile robot to be coupled to the predetermined object and can thereby prevent the autonomous mobile robot from falling over.

In the one aspect, the object may be a structure or a piece of furniture provided in a residential space. This configuration allows a structure or a piece of furniture provided in a residential space to be used not only for its original purpose but also for preventing the autonomous mobile robot from falling over.

Another aspect of this disclosure to achieve the above object is a control method including the steps of: causing an autonomous mobile robot having a platform on which a load is placed and an engaging part that engages with a predetermined object in a surrounding environment to engage the engaging part with the predetermined object; and causing the autonomous mobile robot to raise the platform. This control method allows the autonomous mobile robot to raise the platform with the engaging part engaged with the predetermined object. Thus, the autonomous mobile robot can be prevented from falling over.

Another aspect of this disclosure to achieve the above object is a program that causes a computer of an autonomous mobile robot having a platform on which a load is placed and an engaging part that engages with a predetermined object in a surrounding environment to execute the steps of: performing control to engage the engaging part with the predetermined object; and performing control to raise the platform.

This program allows the autonomous mobile robot to raise the platform with the engaging part engaged with the predetermined object. Thus, the autonomous mobile robot can be prevented from falling over.

This disclosure can provide a carrying system, a control method, and a program that can prevent an autonomous mobile robot from falling over when raising a platform of the autonomous mobile robot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view showing one example of an autonomous mobile robot according to Embodiment 1;

FIG. 2 is a block diagram showing the general system configuration of the autonomous mobile robot according to Embodiment 1;

FIG. 3 is a schematic side view showing a state where a recessed part of the autonomous mobile robot according to Embodiment 1 is fitted on a protruding part of a rack that is a predetermined object;

FIG. 4 is a schematic side view showing a state where a protruding part of an autonomous mobile robot according to Embodiment 2 is fitted in a recessed part of the rack that is the predetermined object;

FIG. 5 is a schematic side view showing a state where a pin of an autonomous mobile robot according to Embodiment 3 is fitted in a recessed part of the rack that is the predetermined object; and

FIG. 6 is a schematic side view showing a state where an engaging part of an autonomous mobile robot according to Embodiment 4 is engaged with an overhang of the rack that is the predetermined object.

### DETAILED DESCRIPTION OF EMBODIMENTS

Embodiments of the present disclosure will be described below with reference to the drawings.

### Embodiment 1

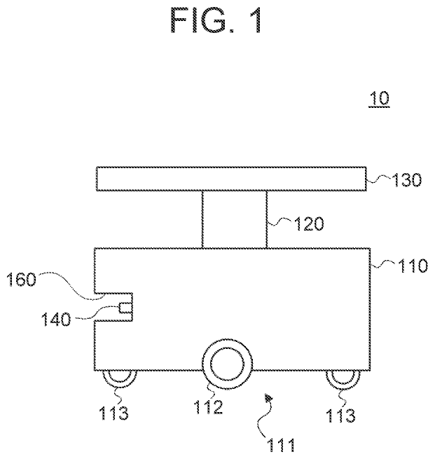

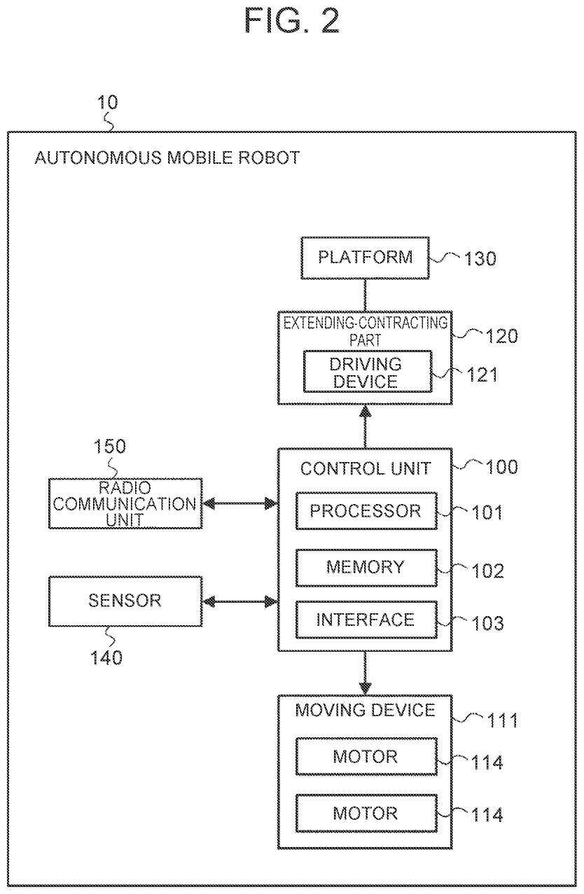

FIG. 1 is a schematic side view showing one example of an autonomous mobile robot 10 according to Embodiment 1. FIG. 2 is a block diagram showing the general system configuration of the autonomous mobile robot 10 according to Embodiment 1.

The autonomous mobile robot 10 is a robot that moves autonomously inside a motion environment, such as a house, facility, warehouse, factory, or outdoor space, and may belong to a carrying system in which a load is supported and carried by the autonomous mobile robot 10. The autonomous mobile robot 10 includes: a casing 110 including a moving device 111 that moves the autonomous mobile robot 10; an extending-contracting part 120 that extends and contracts in an up-down direction; a platform 130 that supports a load placed thereon; a control unit 100 that performs control of the autonomous mobile robot 10 including control of the moving device 111 and the extending-contracting part 120; a sensor 140; and a radio communication unit 150.

The moving device 111 provided in the casing 110 has a pair of left and right drive wheels 112 and a pair of front and rear idler wheels 113 that are rotatably provided on the casing 110, and a pair of motors 114 that drives the respective drive wheels 112 to rotate. The motors 114 rotate the drive wheels 112 through a speed reducer or the like. The motors 114 rotate the drive wheels 112 in response to a control signal from the control unit 100 to thereby allow the autonomous mobile robot 10 to move forward and backward as well as rotate. Thus, the autonomous mobile robot 10 can move to an arbitrary position. This is one example of the configuration of the moving device 111 and the configuration is not limited thereto. For example, the moving device 111 may have arbitrary numbers of drive wheels 112 and idler wheels 113, and an arbitrary configuration that allows the autonomous mobile robot 10 to move to an arbitrary position can be adopted.

A recessed part 160 is provided on a side of the casing 110. The recessed part 160 is one example of an engaging part that engages with a predetermined object in an environment surrounding the autonomous mobile robot 10 when the platform 130 is raised. The recessed part 160 fits on a protruding part provided on a side of the predetermined object. Thus, the recessed part 160 has a shape that fits on the protruding part of the predetermined object. In other words, the recessed part 160 has a shape that corresponds to the shape of the protruding part of the predetermined object. The recessed part 160 in this embodiment is a groove provided linearly in a horizontal direction on the side of the casing 110, but the recessed part 160 may instead be a hole.

The extending-contracting part 120 is an extending-contracting mechanism that extends and contracts in the up-down direction, and is a pillar that supports the platform 130 on an upper side of the casing 110. The extending-contracting part 120 may be configured as a telescopic extending-contracting mechanism. The platform 130 is provided at an upper end of the extending-contracting part 120, and the platform 130 is raised or lowered by operation of the extending-contracting part 120. The extending-contracting part 120 includes a driving device 121, such as a motor, and extends and contracts by being driven by the driving device 121. Thus, the platform 130 is raised or lowered by being driven by the driving device 121. The driving device 121 drives in response to a control signal from the control unit 100. In the autonomous mobile robot 10, instead of the extending-contracting mechanism, a publicly known arbitrary mechanism that controls the level of the platform 130 provided on the upper side of the casing 110 may be used.

The platform 130 is provided on an upper side (a leading end) of the extending-contracting part 120. Thus, the platform 130 is provided above the casing 110 of the autonomous mobile robot 10 through the extending-contracting part 120. The platform 130 is raised and lowered by the driving device 121, such as a motor, and in this embodiment, the platform 130 is used to place a load to be carried by the autonomous mobile robot 10 and to support and lift the load. To carry the load, the autonomous mobile robot 10 moves with the load while the load is supported on the platform 130. Thus, the autonomous mobile robot 10 carries the load. Carrying the load by the autonomous mobile robot 10 need not necessarily involve motion of the autonomous mobile robot 10. That is, carrying the load may be moving the load in the up-down direction by raising or lowering the platform 130.

The platform 130 is formed by a plate member, for example. The shape of this plate member, i.e., the shape of the platform 130 in this embodiment is a flat disc shape, for example, but the plate member may have another arbitrary shape.

The sensor 140 is a sensor that detects environmental information that is information on the motion environment of the autonomous mobile robot 10 (e.g., distance information and image information on an arbitrary object present around the autonomous mobile robot 10). The sensor 140 is, for example, a light detection and ranging (LiDAR) sensor, but may instead be a camera (an RGB-D camera or a stereo camera). The sensor 140 detects the environmental information required for the autonomous mobile robot 10 to move, and outputs the detected environmental information to the control unit 100. It is preferable that the sensor 140 be installed such that the field of view of the sensor 140 is not blocked. The viewing angle of the sensor 140 in the horizontal direction may exceed 180 degrees. In this embodiment, the sensor 140 is provided in the recessed part 160 that is a groove provided linearly in the horizontal direction. This groove is formed in the casing 110 so as to secure the field of view of the sensor 140. Thus, in this embodiment, the sensor 140 that detects information on the environment surrounding the autonomous mobile robot 10 is provided in the recessed part 160. In this embodiment, therefore, the configuration for engaging with the predetermined object in the surrounding environment can also be used to secure the field of view of the sensor 140. The sensor 140 in the example shown in FIG. 1 is located on an inner side of the recessed part 160, but the sensor 140 may instead be provided near a surface of the side of the casing 110. Thus, the distance from the sensor 140 to the surface of the side of the casing 110 is arbitrary.

The radio communication unit 150 is a circuit that performs radio communication to communicate with a server or other robots as necessary, and includes, for example, a radio transmission-reception circuit and an antenna. When the autonomous mobile robot 10 is not configured to communicate with other devices, the radio communication unit 150 may be omitted.

The control unit 100 is a device that controls the autonomous mobile robot 10, and includes a processor 101, a memory 102, and an interface 103. The processor 101, the memory 102, and the interface 103 are connected to one another through a data bus etc.

The interface 103 is an input-output circuit used to communicate with other devices including the moving device 111, the extending-contracting part 120, the sensor 140, and the radio communication unit 150.

The memory 102 is composed of, for example, a combination of a volatile memory and a non-volatile memory. The memory 102 is used to store software (a computer program) including one or more commands that is executed by the processor 101, data used for various processes of the autonomous mobile robot 10, and other pieces of data.

The processor 101 executes processes of the control unit 100 that are to be described later by reading the software (computer program) from the memory 102 and executing the software.

The processor 101 may be, for example, a microprocessor, a microprocessor unit (MPU), or a central processing unit (CPU). The processor 101 may include a plurality of processors. Thus, the control unit 100 is a device that functions as a computer.

The program can be stored using various types of non-transitory computer-readable media and supplied to a computer. These non-transitory computer-readable media include various types of tangible storage media. Examples of non-transitory computer-readable media include a magnetic recording medium (e.g., a flexible disc, a magnetic tape, and a hard disk drive), a magneto-optical recording medium (e.g., a magneto-optical disc), a read-only memory (CD-ROM), a CD-R, a CD-R/W, and a semiconductor memory (e.g., a mask ROM, a programmable ROM (PROM), an erasable PROM (EPROM), a flash ROM, and a random-access memory (RAM)). Further, the program may be supplied to a computer by various types of transitory computer-readable media. Examples of transitory computer-readable media include electrical signals, optical signals, and electromagnetic waves. The transitory computer-readable medium can supply the program to a computer through a wired communication channel, such as an electric wire or an optical fiber, or a wireless communication channel.

Next, the processes of the control unit 100 will be described.

The control unit 100 controls the operation of the autonomous mobile robot 10. Specifically, the control unit 100 controls the operation of the moving device 111 and the extending-contracting part 120. The control unit 100 sends a control signal to the motors 114 of the moving device 111 and can thereby control the rotation of the drive wheels 112 so as to move the autonomous mobile robot 10 to an arbitrary position. Further, the control unit 100 sends a control signal to the driving device 121 of the extending-contracting part 120 and can thereby control the level of the platform 130.

The control unit 100 may control the motion of the autonomous mobile robot 10 by performing commonly known control, such as feedback control or robust control, based on, for example, information on the rotation of the drive wheels 112 detected by rotation sensors provided on the drive wheels 112. Further, the control unit 100 may cause the autonomous mobile robot 10 to move autonomously by controlling the moving device 111 based on information such as environmental information detected by the sensor 140 and information on a map of the motion environment.

For example, before raising or lowering the platform 130, the control unit 100 moves the autonomous mobile robot 10 to the position of the predetermined object in the surrounding environment to engage the predetermined object and the engaging part (in this embodiment, the recessed part 160). Here, the predetermined object is, for example, a structure or a piece of furniture provided in a residential space, such as a house. The piece of furniture here is not limited to a shelf (rack) or the like but may also be an electric appliance installed in a residential space, such as a refrigerator. The shelf may be a shelf configured to move autonomously. Alternatively, the predetermined object may be a structure provided in a place other than a residential space. In this embodiment, the control unit 100 controls the moving device 111 so as to fit the recessed part 160 onto a protruding part provided on a wall surface or a side of a piece of furniture. For example, the control unit 100 fits the recessed part 160 onto the protruding part of the predetermined object by moving the autonomous mobile robot 10 close to the protruding part of the predetermined object with the recessed part 160 facing the protruding part.

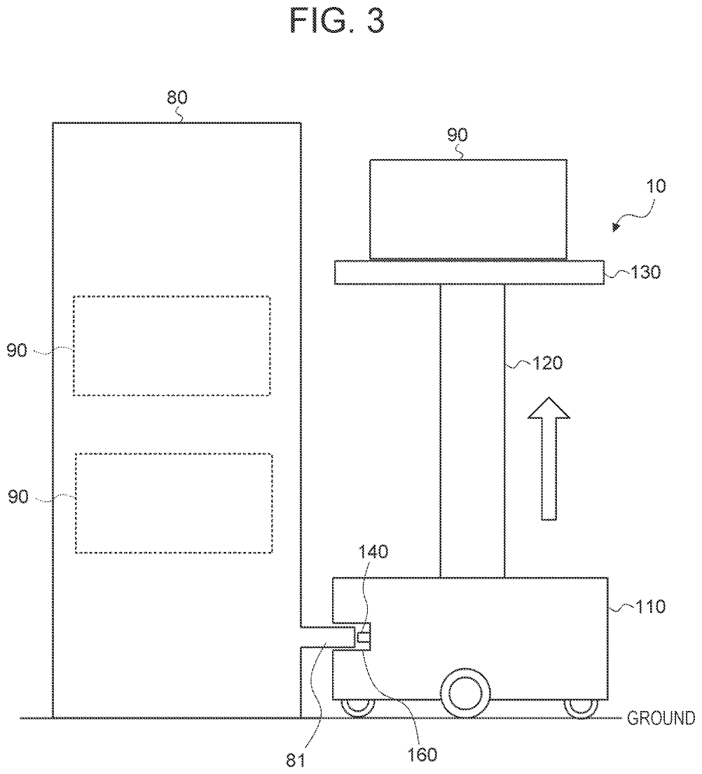

FIG. 3 is a schematic side view showing a state where the recessed part 160 of the autonomous mobile robot 10 according to this embodiment is fitted on a protruding part 81 of a rack 80 that is the predetermined object. A box 90 that is a load is placed on the platform 130 of the autonomous mobile robot 10 shown in FIG. 3, and the autonomous mobile robot 10 has lifted the box 90 up to the level of a place where the box 90 is to be stored. The protruding part 81 is provided on a side of the rack 80. Here, the level of the installation position of the recessed part 160 of the autonomous mobile robot 10 corresponds to the level of the installation position of the protruding part 81 of the rack 80. While the shape of the protruding part 81 in the example shown in FIG. 3 is a rectangular parallelepiped shape protruding in the horizontal direction, the shape of the protruding part 81 may be an arbitrary shape protruding in the horizontal direction, such as a prism shape or a columnar shape. A leading end of the protruding part 81 may have a U-shape such that the protruding part 81 does not hit the sensor 140 provided in the recessed part 160. When the recessed part 160 is fitted on the protruding part 81 of the rack 80 as shown in FIG. 3, the autonomous mobile robot 10 can stably support itself and be prevented from falling over. In particular, when the platform 130 is raised, as the position of the center of gravity is raised, the autonomous mobile robot 10 may fail to stably support itself. In this embodiment, however, since the recessed part 160 is fitted on the predetermined object, the autonomous mobile robot 10 is less likely to fall over.

To prevent the autonomous mobile robot 10 from falling over, the control unit 100 may perform the following control. The control unit 100 may raise the platform 130 only when engagement of the engaging part (in this embodiment, the recessed part 160) is detected. In other words, the control unit 100 may prohibit the platform 130 from being raised when engagement of the engaging part is not detected. Thus, the autonomous mobile robot 10 can be more reliably prevented from falling over. Engagement of the engaging part may be detected by, for example, a sensor that detects whether any object is present in the recessed part 160. The sensor 140 may be used as this sensor. Further, the control unit 100 may perform control so as to prohibit motion by the moving device 111 when engagement of the engaging part is detected.

Thus, the control unit 100 may perform control and processes including the control for engaging the engaging part (in this embodiment, the recessed part 160) with the predetermined object, the process of determining engagement of the engaging part, and the control for raising the platform 130.

Embodiment 1 has been described so far. As described above, the autonomous mobile robot 10 according to this embodiment has the recessed part 160 that fits on the protruding part of the predetermined object. Thus, the autonomous mobile robot 10 can be coupled to the predetermined object and thereby prevented from falling over.

### Embodiment 2

In Embodiment 1, the autonomous mobile robot 10 includes the recessed part 160 as the engaging part and the predetermined object in the surrounding environment includes the protruding part. Alternatively, the autonomous mobile robot 10 may include a protruding part. In the following, differences from Embodiment 1 will be described while description of the same components and control as in Embodiment 1 will be omitted as appropriate.

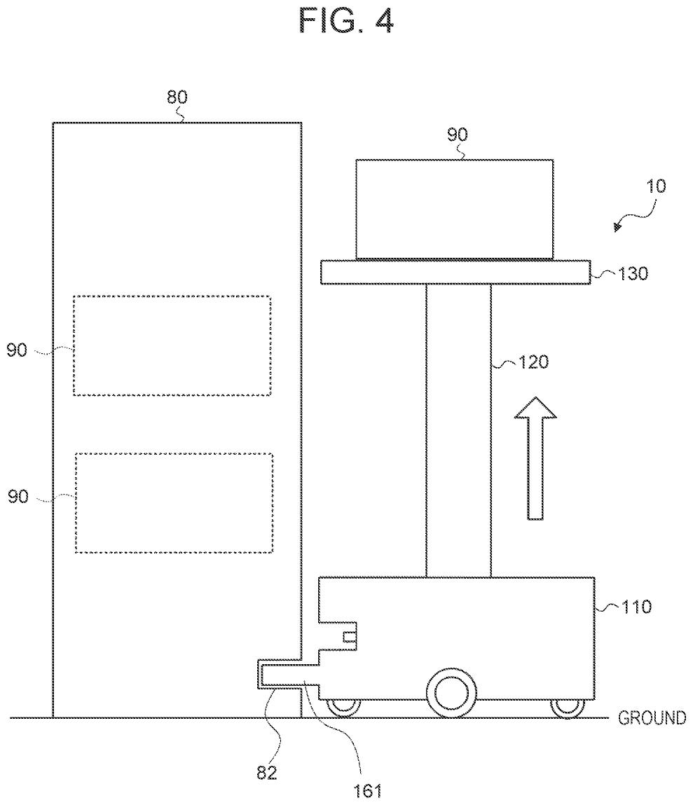

FIG. 4 is a schematic side view showing a state where a protruding part 161 of the autonomous mobile robot 10 according to this embodiment is fitted in a recessed part 82 of the rack 80 that is the predetermined object. While the predetermined object in the example shown in FIG. 4 is the rack 80, the predetermined object is not limited thereto. Also in this embodiment, the predetermined object may be a structure or a piece of furniture provided in a residential space. For example, a part into which the protruding part 161 is fitted may be a recessed part provided in a wall surface or on a side of a piece of furniture.

In this embodiment, the protruding part 161 is provided on a side of the casing 110 of the autonomous mobile robot 10. The protruding part 161 is another example of the engaging part that engages with the predetermined object in the environment surrounding the autonomous mobile robot 10 when the platform 130 is raised. The protruding part 161 fits into a recessed part provided on a side of the predetermined object, such as the rack 80. Thus, the protruding part 161 has a shape that fits into the recessed part of the predetermined object. In other words, the protruding part 161 has a shape that corresponds to the shape of the recessed part of the predetermined object. While the shape of the protruding part 161 in the example shown in FIG. 4 is a rectangular parallelepiped shape protruding in the horizontal direction, the shape of the protruding part 161 may be an arbitrary shape protruding in the horizontal direction, such as a prism shape or a columnar shape. The recessed part 82 is provided on the side of the rack 80. The recessed part 82 has a shape that corresponds to the shape of the protruding part 161 of the autonomous mobile robot 10. The recessed part 82 in the example shown in FIG. 4 is a groove provided linearly in the horizontal direction on the side of the rack 80, but the recessed part 82 may instead be a hole. Here, the level of the installation position of the protruding part 161 of the autonomous mobile robot 10 corresponds to the level of the installation position of the recessed part 82 of the rack 80. When the protruding part 161 is fitted in the recessed part 82 of the rack 80 as shown in FIG. 4, the autonomous mobile robot 10 can stably support itself and be prevented from falling over. Thus, also in this embodiment, the autonomous mobile robot 10 can be coupled to the predetermined object and thereby prevented from falling over.

### Embodiment 3

Next, Embodiment 3 will be described. This embodiment is different from the above-described embodiments in that the engaging part that engages with a predetermined object in the environment surrounding the autonomous mobile robot 10 is moved in and out of the autonomous mobile robot 10. In the following, differences from Embodiment 1 will be described while description of the same components and control as in Embodiment 1 will be omitted as appropriate.

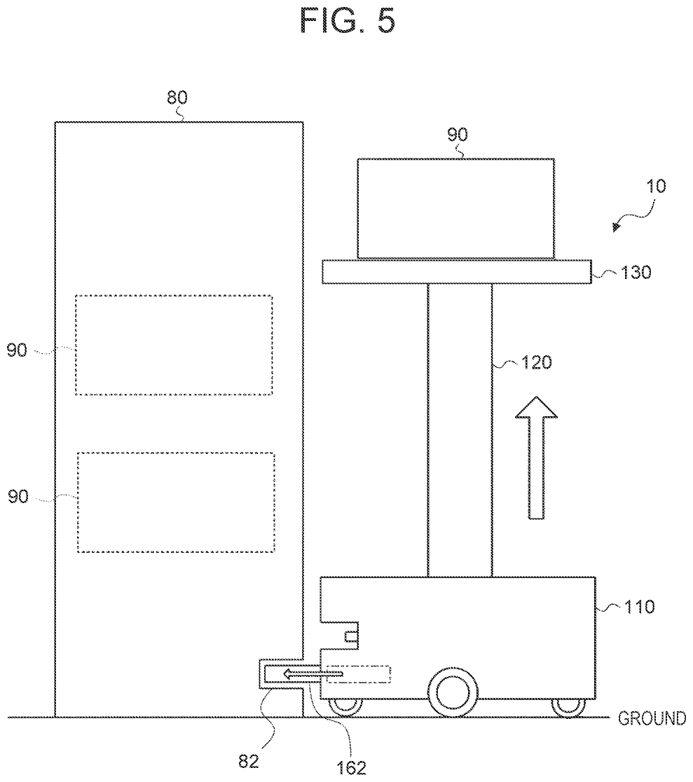

FIG. 5 is a schematic side view showing a state where a pin 162 of the autonomous mobile robot 10 according to this embodiment is fitted in a recessed part 82 of the rack 80 that is the predetermined object. While the predetermined object in the example shown in FIG. 5 is the rack 80, the predetermined object is not limited thereto. Also in this embodiment, the predetermined object may be a structure or a piece of furniture provided in a residential space. For example, a part into which the pin 162 is fitted may be a recessed part provided in a wall surface or on a side of a piece of furniture.

In this embodiment, the autonomous mobile robot 10 is provided with the pin 162 that is moved out from the side of the casing 110 of the autonomous mobile robot 10 toward the rack 80 that is the predetermined object. The pin 162 is another example of the engaging part that engages with the predetermined object in the environment surrounding the autonomous mobile robot 10 when the platform 130 is raised. In the configuration shown in FIG. 5, the pin 162 can be moved in the horizontal direction relatively to the casing 110, and thus a state where the pin 162 has been moved out to an outside of the casing 110 and a state where the pin 162 has been retracted to an inside of the casing 110 can be assumed. This motion of the pin 162 may be performed by the control unit 100. For example, when the autonomous mobile robot 10 comes to the predetermined object, the control unit 100 moves the pin 162 out and inserts it into the recessed part of the predetermined object (e.g., the recessed part 82 of the rack 80). Thus, the pin 162 is fitted into the recessed part provided on the side of the predetermined object, such as the rack 80. The shape of the pin 162 in the example shown in FIG. 5 is a columnar shape, but the pin 162 may have another shape, such as a prism shape. The recessed part 82 into which the pin 162 is fitted is provided on the side of the rack 80, and, for example, the recessed part 82 has a shape that corresponds to the shape of the pin 162 of the autonomous mobile robot 10. The recessed part 82 in the example shown in FIG. 5 is a hole provided on the side of the rack 80, but the recessed part 82 may instead be a groove provided linearly in the horizontal direction. Here, the level of the installation position of the pin 162 of the autonomous mobile robot 10 corresponds to the level of the installation position of the recessed part 82 of the rack 80. When the pin 162 is fitted in the recessed part 82 of the rack 80 as shown in FIG. 5, the autonomous mobile robot 10 can stably support itself and be prevented from falling over. Thus, also in this embodiment, the autonomous mobile robot 10 can be coupled to the predetermined object and thereby prevented from falling over.

While the configuration in which the pin 162 is moved out from the autonomous mobile robot 10 in the horizontal direction has been shown in this embodiment, a configuration in which the pin 162 is moved out in a vertical direction may be adopted. In this case, the predetermined object may be a floor. Specifically, for example, the control unit 100 may move the pin 162 out from the casing 110 of the autonomous mobile robot 10 in a downward direction so as to be fitted into a recessed part in the floor. Thus, the object with which the autonomous mobile robot engages may be a structure, such as a floor. While the autonomous mobile robot 10 in this embodiment includes the pin 162, alternatively, the predetermined object may include a pin that can be moved in and out of the object and this pin may be fitted into a recessed part of the autonomous mobile robot 10. Further, both fitting by a pin and fitting by the configuration shown in Embodiment 1 or Embodiment 2 may be performed.

### Embodiment 4

In the above-described embodiments, the engaging part that engages with the predetermined object in the surrounding environment is a projection or a recessed part provided in the autonomous mobile robot 10. However, another configuration may be adopted. This embodiment is different from the above-described embodiments in that the engaging part is an upper surface of the casing 110. In the following, differences from Embodiment 1 will be described while description of the same components and control as in Embodiment 1 will be omitted as appropriate.

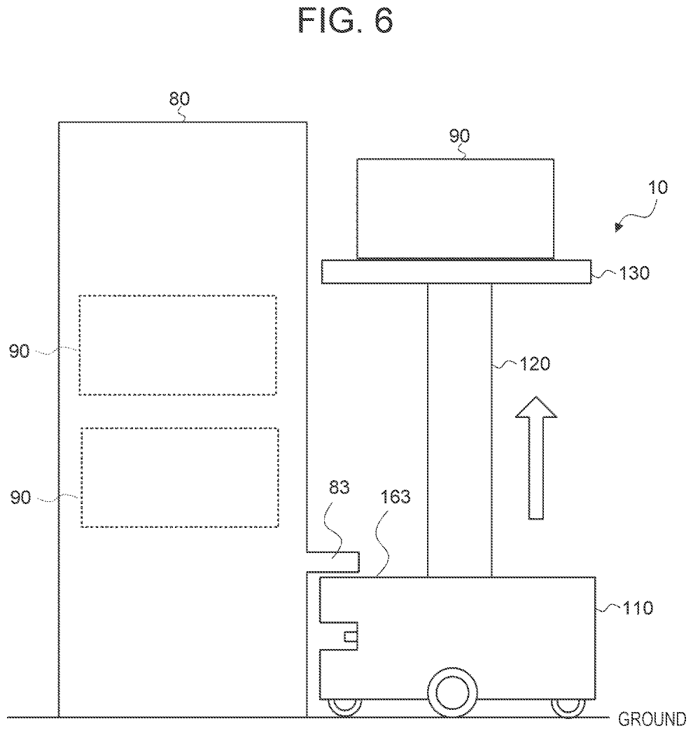

FIG. 6 is a schematic side view showing a state where an engaging part 163 of the autonomous mobile robot 10 according to this embodiment is engaged with an overhang 83 of the rack 80 that is the predetermined object. While the predetermined object in the example shown in FIG. 6 is the rack 80, the predetermined object is not limited thereto. Also in this embodiment, the predetermined object may be a structure or a piece of furniture provided in a residential space. For example, a part with which the engaging part 163 is engaged may be an overhang provided on a wall surface or a side of a piece of furniture.

In this embodiment, the level of the upper surface of the casing 110 of the autonomous mobile robot 10 is a level corresponding to the level of a lower surface of the overhang 83 provided on the rack 80 that is the predetermined object so as to protrude in the horizontal direction. Thus, the upper surface (the engaging part 163) of the casing 110 is another example of the engaging part that engages with the predetermined object in the environment surrounding the autonomous mobile robot 10 when the platform 130 is raised. The overhang 83 is provided on the side of the rack 80, and under the overhang 83, there is a space between the lower surface of the overhang 83 and the floor (ground). The engaging part 163 engages with the lower surface of the overhang 83 provided on the side of the predetermined object, such as the rack 80. In other words, the casing 110 fits into the space under the overhang 83. Therefore, the casing 110 itself can be said to constitute the engaging part. Thus, in this embodiment, the casing 110 is configured such that the level of the casing 110 from the floor (ground) (the length of the casing 110 in the up-down direction) corresponds to the level of the lower surface of the overhang 83. When the casing 110 is fitted in the space defined by the overhang 83 of the rack 80 and the floor (ground) as shown in FIG. 6, the autonomous mobile robot 10 can stably support itself and be prevented from falling over. Thus, also in this embodiment, the autonomous mobile robot 10 can be coupled to the predetermined object and thereby prevented from falling over. Also in this embodiment, the engaging structure may be used in combination with the engaging structures shown in the above-described other embodiments. While the overhang 83 in the example shown in FIG. 6 has the same configuration as the protruding part 81 of FIG. 3, the length of the overhang 83 in the up-down direction is arbitrary; for example, the level of an upper surface of the overhang 83 may reach the level of a topmost surface of the object (rack 80). Thus, space into which the autonomous mobile robot 10 can enter should be provided under the overhang 83, while space above the overhang 83 need not be provided.

The present disclosure is not limited to the above-described embodiments but can be changed as appropriate within a range that does not depart from the gist of the disclosure.

What is claimed is:

1. A carrying system in which a load is carried by an autonomous mobile robot, wherein the autonomous mobile robot has:
a platform on which the load is placed;
a control unit that controls a level of the platform; and
an engaging part that engages with a predetermined object in a surrounding environment when the platform is raised.

2. The carrying system according to claim 1, wherein the control unit raises the platform only when engagement of the engaging part is detected.

3. The carrying system according to claim 1, wherein the engaging part is a recessed part that fits on a protruding part of the object.

4. The carrying system according to claim 1, wherein the engaging part is a protruding part that fits into a recessed part of the object.

5. The carrying system according to claim 1, wherein the engaging part is a pin that is moved out from a casing of the autonomous mobile robot toward the object.

6. The carrying system according to claim 1, wherein:
the platform is provided above a casing of the autonomous mobile robot through a pillar that supports the platform on an upper side of the casing;
the engaging part is an upper surface of the casing; and
a level of the upper surface is a level corresponding to a level of a lower surface of an overhang that is provided on the object so as to protrude in a horizontal direction.

7. The carrying system according to claim 1, wherein the object is a structure or a piece of furniture provided in a residential space.

8. A control method comprising the steps of:
causing an autonomous mobile robot having a platform on which a load is placed and an engaging part that engages with a predetermined object in a surrounding environment to engage the engaging part with the predetermined object; and
causing the autonomous mobile robot to raise the platform.

9. A program that causes a computer of an autonomous mobile robot having a platform on which a load is placed and an engaging part that engages with a predetermined object in a surrounding environment to execute the steps of:
performing control to engage the engaging part with the predetermined object; and
performing control to raise the platform.
